(19) United States
(12) Patent Application Publication
(10) Pub. No.: US 2025/0331454 A1
(43) Pub. Date: Oct. 30, 2025

(54) MOWER HAVING MULTI-MODE CUTTING DECK

(71) Applicant: MTD PRODUCTS INC, Valley City, OH (US)

(72) Inventors: Theodore Nichols, Middleburg Heights, OH (US); Christian Emhoff, Valley City, OH (US); Heath Rohrbaugh, Medina, OH (US)

(21) Appl. No.: 19/193,165

(22) Filed: Apr. 29, 2025

Related U.S. Application Data
(60) Provisional application No. 63/640,010, filed on Apr. 29, 2024.

(51) Int. Cl. A01D 34/81; A01D 34/00; A01D 34/66; A01D 42/00; A01D 101/00

(52) U.S. Cl. CPC A01D 34/81; A01D 34/005; A01D 34/66; A01D 42/005; A01D 2101/00

(57) ABSTRACT

Systems and methods that facilitate operation of a mow deck comprising a plurality of mow spindles in a mulching mode and/or a side discharge mode are discussed. In the mulching mode, the plurality of mow spindles comprises a first set of one or more mow spindles configured to rotate in a first direction and a second set of one or more mow spindles configured to rotate in a second direction that is different from the first direction. Additionally, different mow spindles of the plurality can rotate at different speeds.

### CROSS-REFERENCE TO RELATED APPLICATIONS

This application claims the benefit of U.S. Provisional Application No. 63/640,010, filed Apr. 29, 2024, and which is hereby incorporated by reference within the present disclosure in its entirety and for all purposes.

### INCORPORATION BY REFERENCE

The following are hereby incorporated by reference within the present disclosure in their respective entireties and for all purposes: U.S. patent application Ser. No. 16/782,409 filed Feb. 5, 2020, U.S. patent application Ser. No. 17/693,727 filed Mar. 14, 2022, U.S. patent application Ser. No. 18/370,236 filed Sep. 19, 2023, U.S. Provisional Application No. 62/907,992 filed Sep. 30, 2019, U.S. Provisional Application No. 62/801,202 filed Feb. 5, 2019, U.S. Provisional Application No. 63/160,524 filed Mar. 12, 2021, U.S. Provisional Application No. 63/213,646 filed Jun. 22, 2021, and U.S. Provisional Application No. 63/408,308 filed Sep. 20, 2022.

### FIELD OF DISCLOSURE

The disclosed subject matter pertains to apparatuses and methods for lawn maintenance devices having a mow deck and/or cutting system capable of operating according to one or more cutting modes discussed herein, as well as such a mow deck and/or cutting system.

### BACKGROUND

Manufacturers of power equipment for outdoor maintenance applications offer many types of machines for general maintenance and mowing applications. Generally, these machines can have a variety of forms depending on application, from general urban or suburban lawn maintenance, rural farm and field maintenance, to specialty applications. Even specialty applications can vary significantly. For example, mowing machines suitable for sporting events requiring moderately precise turf, such as soccer fields or baseball outfields may not be suitable for events requiring very high-precision surfaces such as golf course greens, tennis courts and the like.

Lawn maintenance equipment can employ a variety of blades and/or mow decks, some of which are specialized for a variety of purposes. As one example, different blades and/or mow decks can be employed for mulching (e.g., where smaller grass clippings can be desirable, etc.) than for bagging of grass. In some scenarios, the same mow deck can be reused for multiple purposes, such as by the addition or removal of a mulch kit and/or changing of blades for specific applications. In general, the longer grass clippings are recirculated by a cutting system, the more power is expended by the lawn maintenance equipment. While this may be intentional in some systems and scenarios (e.g., mulching, etc.), repeated circulation of grass clippings in a mowing chamber can be inefficient and can increase power consumption.

### BRIEF SUMMARY

The following presents a simplified summary in order to provide a basic understanding of some aspects of the disclosure. This summary is not an extensive overview of the disclosure. It is not intended to identify key/critical elements or to delineate the scope of the disclosure. Its sole purpose is to present some concepts of the disclosure in a simplified form as a prelude to the more detailed description that is presented later.

Various embodiments of the present disclosure include mow decks and cutting systems capable of operating according to one or more cutting modes discussed herein, as well as such a mow deck and/or cutting system. One example embodiment comprises a lawn maintenance apparatus, comprising: a frame; a plurality of drive wheels rotatable about a drive wheel rotation axis; at least one of an operator seat or a standing platform secured to the frame; operator controls for operator-initiated functions of the lawn maintenance apparatus; and a mow deck secured to the frame, wherein the mow deck comprises a plurality of mow spindles that each comprise one or more associated mow blades, wherein each mow spindle of the plurality of mow spindles is configured to drive one or more mow blades, and wherein the mow deck is configured to operate according to one or more modes of operation, wherein the one or more modes of operation comprise a first mulch mode, wherein in the first mulch mode of operation, the plurality of mow spindles comprises a first set of one or more mow spindles configured to rotate in a first direction and a second set of one or more mow spindles configured to rotate in a second direction that is different from the first direction.

A second example embodiment comprises a lawn maintenance apparatus, comprising: a frame; a plurality of drive wheels rotatable about a drive wheel rotation axis; at least one of an operator seat or a standing platform secured to the frame; operator controls for operator-initiated functions of the lawn maintenance apparatus; and a mow deck secured to the frame, wherein the mow deck comprises a plurality of mow spindles that each comprise one or more associated mow blades, wherein each mow spindle of the plurality of mow spindles is configured to drive one or more mow blades, and wherein the mow deck is configured to operate according to one or more modes of operation, wherein the one or more modes of operation comprise a first mulch mode, wherein in the first mulch mode of operation, the plurality of mow spindles comprises a first set of one or more mow spindles configured to rotate at a first speed and a second set of one or more mow spindles configured to rotate at a second speed that is different from the first speed.

To accomplish the foregoing and related ends, certain illustrative aspects of the disclosure are described herein in connection with the following description and the drawings. These aspects are indicative, however, of but a few of the various ways in which the principles of the disclosure can be employed and the subject disclosure is intended to include all such aspects and their equivalents. Other advantages and features of the disclosure will become apparent from the following detailed description of the disclosure when considered in conjunction with the drawings.

### BRIEF DESCRIPTION OF THE DRAWINGS

FIG. 1 illustrates a bottom view of an example mow deck according to various embodiments discussed herein.

FIG. 2 illustrates an image of the example mow deck of FIG. 1 operating in a side discharge mode of operation, according to various aspects discussed herein.

FIG. 3 illustrates an image of the example mow deck of FIG. 1 operating in a mulching mode of operation, according to various aspects discussed herein.

FIG. 4 illustrates a left perspective view of an example embodiment of a convertible lawn maintenance apparatus in a seated configuration, according to various aspects discussed herein.

It should be noted that the drawings are diagrammatic and not drawn to scale. Relative dimensions and proportions of parts of the figures have been shown exaggerated or reduced in size for the sake of clarity and convenience in the drawings. The same reference numbers are generally used to refer to corresponding or similar features in the different embodiments, except where clear from context that same reference numbers refer to disparate features. Accordingly, the drawings and description are to be regarded as illustrative in nature and not as restrictive.

### DETAILED DESCRIPTION

The following terms are used throughout the description, the definitions of which are provided herein to assist in understanding various aspects of the subject disclosure.

As used in this application, the terms “outdoor power equipment”, “outdoor power equipment machine”, “power equipment”, “maintenance machine” and “power equipment machine” are used interchangeably and are intended to refer to any of robotic, partially robotic ride-on, walk-behind, sulky equipped, autonomous, semi-autonomous (e.g., user-assisted automation), remote control, or multi-function variants of any of the following: powered carts and wheel barrows, lawn mowers, lawn and garden tractors, lawn trimmers, lawn edgers, lawn and leaf blowers or sweepers, hedge trimmers, pruners, loppers, chainsaws, rakes, pole saws, tillers, cultivators, aerators, log splitters, post hole diggers, trenchers, stump grinders, snow throwers (or any other snow or ice cleaning or clearing implements), lawn, wood and leaf shredders and chippers, lawn and/or leaf vacuums, pressure washers, lawn equipment, garden equipment, driveway sprayers and spreaders, and sports field marking equipment.

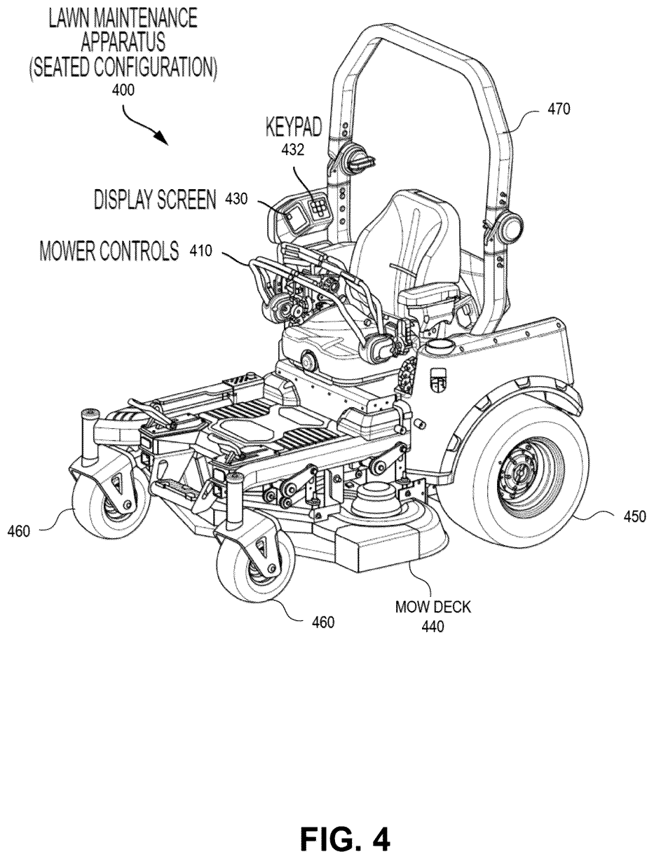

Various embodiments can comprise a lawn maintenance apparatus comprising a mow deck and cutting system capable of operating according to one or more cutting modes discussed herein and/or such a mow deck and cutting system. A lawn maintenance apparatus according to aspects discussed herein can be a ride-on lawn maintenance apparatus of any of a variety of configurations, such as a seated lawn maintenance apparatus, a standing lawn maintenance apparatus, or a convertible seated/standing lawn-maintenance apparatus, such as the example lawn maintenance apparatuses described in connection with FIGS. 4-9 below.

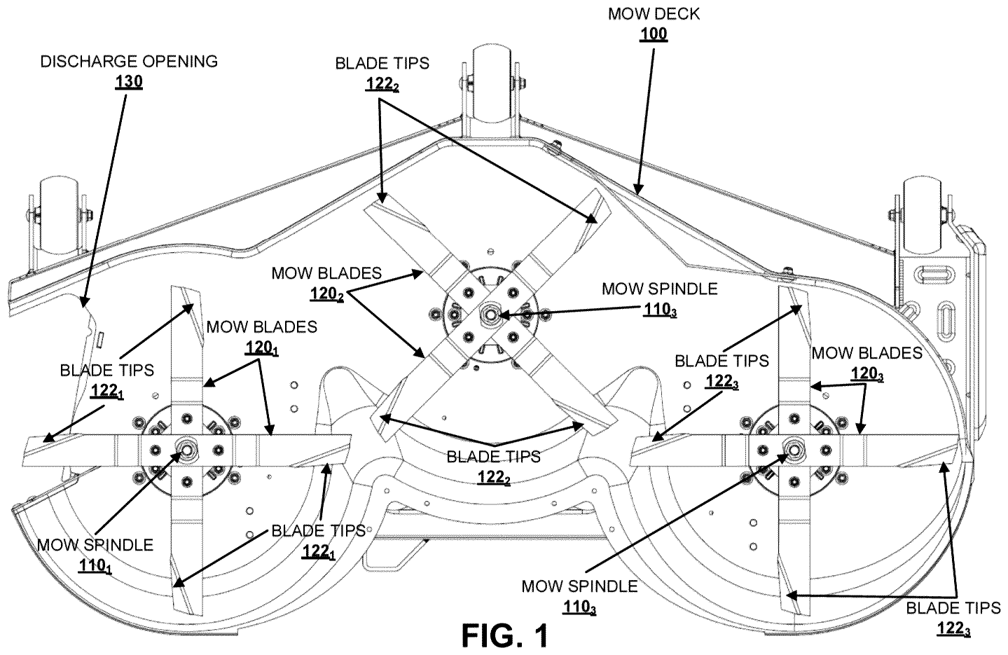

Referring to FIG. 1, illustrated is a bottom view of an example mow deck 100 according to various embodiments discussed herein. Mow deck 100 can comprise a plurality of mow spindles 110;. Although for the purposes of illustration, example embodiments are shown with three mow spindles 1101, 1102, and 1103, various embodiments can comprise two, three, four, or more than four mow spindles 110;. Each mow spindle 110; can be coupled to one or more mow blades 120; (with two mow blades 120; per mow spindle 110; in the embodiment of FIG. 1, although more or fewer can be used in other embodiments). Each mow blade 120; can have one or more blade tips 122; (two in FIG. 1, although more or fewer can be used in other embodiments). FIG. 1 shows an arrangement of two mow blades 120; substantially perpendicular to one another for four substantially equally spaced blade tips 122; coupled to each mow spindle 110i, which can provide improved efficiency when compared to existing mow decks (e.g., cutting grass at a comparable rate for less energy, etc.). In various embodiments, the substantially equally spaced blade tips can be rotated at a lower RPM, using less energy, while also cutting more efficiently (less new grass per blade tip) than other lawn maintenance equipment. It is to be understood, however, that while FIG. 1 provides a specific embodiment to illustrate concepts and components associated with various embodiments, systems and techniques discussed herein for employing multiple operating modes in connection with a mow deck (e.g., mow deck 100, etc.) can be employed in connection with a variety of mow decks that can have a variety of arrangements of mow spindles, mow blades, and/or blade tips which can be similar to and/or distinct from those of FIG. 1 in one or more respects.

In various embodiments, the speed and/or direction of each mow spindle 110; can be independent from and independently controlled from the speed and/or direction of each other mow spindle 110j. While some embodiments can allow for control of the speed and/or direction of each mow spindle 110i, other embodiments can allow for selection between one of a plurality of operating modes. Each operating mode can have a specific speed and direction associated with each mow spindle 110; of the plurality of mow spindles 110j. Mow deck 130 can also comprise a discharge opening 130 (a side discharge opening is shown, but in various embodiments other types of discharge openings such as top discharge, rear discharge, etc. can be employed), which can remain open for some operating modes (e.g., one or more side/top/rear discharge modes, bagging mode(s), etc.) and closed (e.g., blocked by a mulch plug, etc.) for other operating modes (e.g., one or more mulch modes, etc.).

In some embodiments, different mow spindles can be rotated with different angular velocities, in terms of direction of rotation and/or speed of rotation. For example, for mulching applications, while some mow spindles (e.g., left and right mow spindles 1101 and 1103 in a three-spindle deck like mow deck 100 discussed above, etc.) can rotate at speeds discussed above, one or more mow spindles (e.g., a center spindle 1102, etc.) can rotate its associated blades with a higher speed than discussed above, but which can still be less than other lawn maintenance equipment. In the same or other embodiments, the direction of rotation of a first mow spindle can differ from that of a second mow spindle (e.g., rotating one side spindle in a different direction than the other two in a mode, etc.), which can alter the flow of air and grass clippings under mow deck 100, including the amount of grass clippings exiting mow deck 100 from the rear relative to the amount of grass clippings exiting mow deck 100 via grass discharge 130.

In various embodiments, discharge and/or bagging modes can employ the same or substantially similar blade tip speeds for each mow spindle 110j. However, in some embodiments (e.g., based on the geometry of the mow deck, air flow within/under mow deck, etc.), different speeds can be employed on different mow spindles in connection with discharge and/or bagging modes.

For a high efficiency mow deck such as mow deck 100, the substantially equally spaced blade tips 122; can be rotated at a significantly lower speed than a maximum allowable (MA) (per the American National Standards Institute (ANSI)) allowed blade speed (19000 feet per minute) speed. For example, in various embodiments, blade speed can vary based on cutting modes (e.g., discharge, mulching, or bagging, etc.) and/or performance or grass difficulty modes (e.g., low, medium, or high performance/grass difficulty, etc.), but can be approximately 60-85% of MA, approximately 60-68% of MA for low performance/grass difficulty, approximately 68-76% of MA for medium performance/grass difficulty, and/or approximately 76-85% for high performance/grass difficulty. Rotational speeds of embodiments discussed herein that employ a high efficiency mow deck such as mow deck 100 can also be lower (e.g., thereby providing energy savings, etc.) than the speed(s) of other (e.g., two blade tips, four blade tips grouped into two closely spaced pairs, etc.) lawn maintenance equipment (e.g., operating at 95-98% or greater of MA), while still providing an approximately 33% improvement in terms of reducing the amount of new grass entering the deck between successive blade tips. Specific example RPM ranges can vary based on deck size and mow blade radius/diameter. As noted, systems and techniques discussed herein can also be employed in connection with less efficient mow decks than mow deck 100. Such less efficient mow decks can employ blade speeds that are a higher percentage of MA, and which can depend on the specific mow deck, mow blades, and/or blade tips.

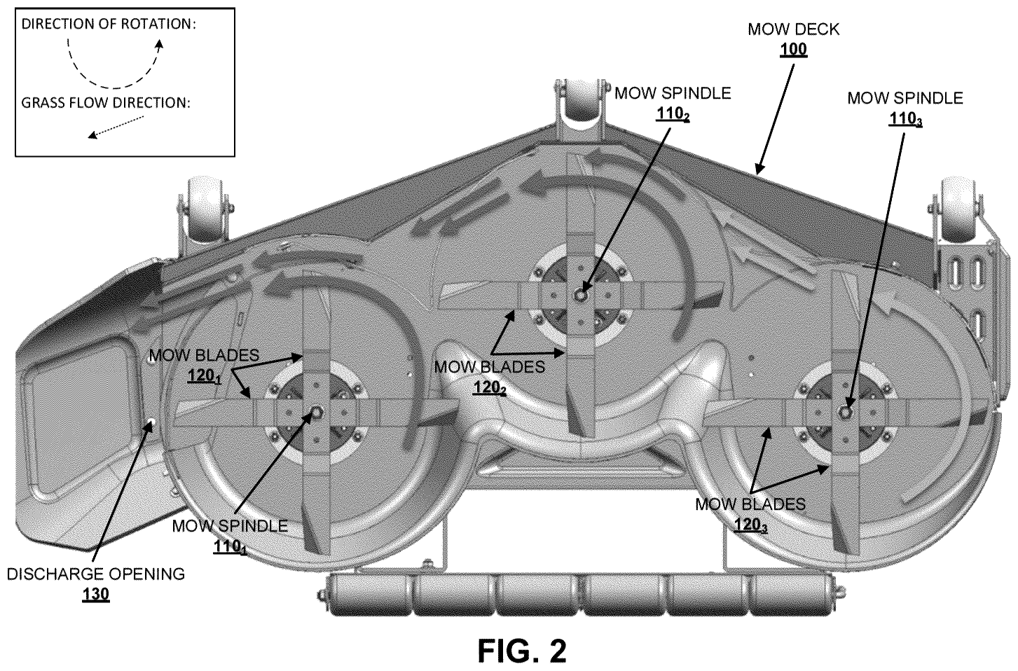

Referring to FIG. 2, illustrated is an image of example mow deck 100 operating in a side discharge mode of operation, according to various aspects discussed herein. In the side discharge mode of operation (and in other discharge operating modes, which can vary based on the type of discharge), each of the mow spindles 110; can rotate in the same direction, which can be a direction (counterclockwise in FIG. 2) that moves grass clippings and air toward the discharge opening 130. In various embodiments, a plurality of discharge operating modes can be available, such as different modes for different levels of cutting efficiency and/or grass difficulty. In a side discharge mode of operation, each mow spindle 110; can rotate in the same direction at the same speed, which can vary based on energy efficiency or consumption of the operating mode (e.g., turbo, standard, energy saving or eco mode, etc.). Example speeds of operation are 63-81% of MA in various modes, around 65-79% of MA in various modes, around 63-69% or 65-67% of MA in a high energy efficiency mode (e.g., eco or energy saving, etc.), around 70-74% or 72% in a middle energy efficiency mode (e.g., normal operation, etc.), around 76-81% or 78-79% in a low energy efficiency mode (e.g., turbo mode, etc.). The specific RPM can depend on the length of the mow blade.

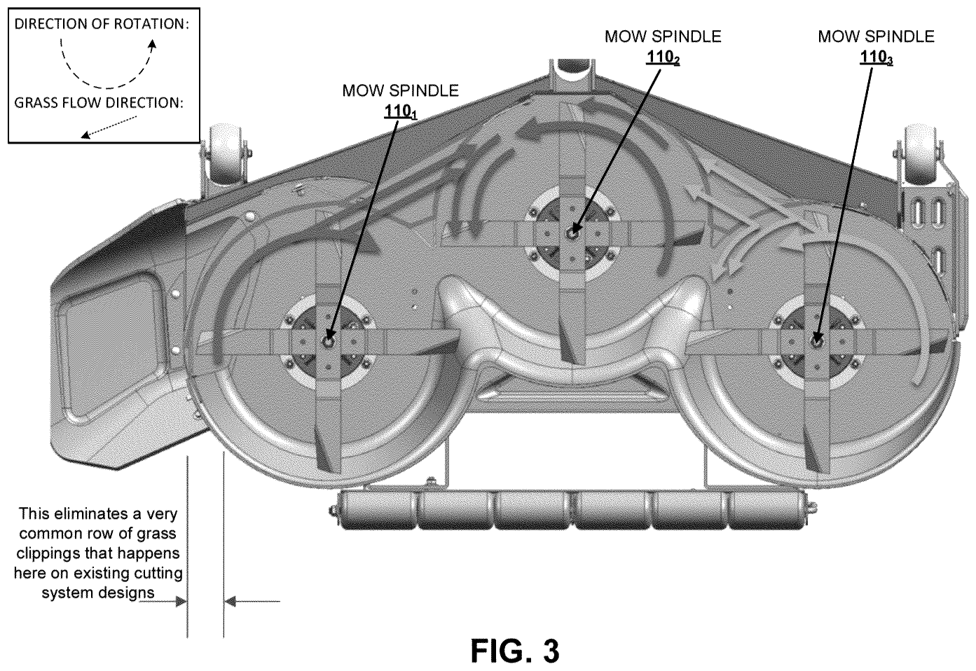

Referring to FIG. 3, illustrated is an image of example mow deck 100 operating in a mulching mode of operation, according to various aspects discussed herein. In various mulching modes of operation, a first set of mow spindles can rotate in a first direction, while a second set of mow spindles can rotate in a second direction distinct from the first direction. FIG. 3 shows one example arrangement of mow spindle directions for mulching mode(s), wherein the mow spindles not adjacent to discharge opening 130 (center mow spindle 1102 and right mow spindle 1103) can rotate in a first direction (counterclockwise in FIG. 3) while the mow spindle adjacent to discharge opening 130 (leftmost mow spindle 1101) can rotate in a second (different) direction (clockwise in FIG. 3).

In mow deck 100, blade tips 122; are arranged on mow blades 120; for cutting grass when rotated counterclockwise in FIGS. 1-3. In some embodiments wherein a mow spindle 110; is configured to rotate clockwise, alternate mow blades (e.g., mirror images of mow blades 120;, etc.) can be attached to that mow spindle for cutting grass when rotated clockwise. Alternatively, mow blades configured to cut in both directions can be employed.

In existing cutting systems, mulching operating modes involve all mow spindles rotating in the same direction (e.g., toward the (plugged) discharge opening 130), which creates a row of grass clippings underneath that edge of the mow deck, as indicated in FIG. 3. However, in various mulching operating modes discussed herein, a first set of mow spindles (e.g., 1102 and 1103, etc.) can rotate in a first direction and a second set of mow spindles (e.g., 1101, etc.) can rotate in a second direction that is distinct from (e.g., the opposite of, etc.) the first direction.

In the specific example of FIG. 3, mow spindles 1102 and 1103 rotate counterclockwise (pushing newly cut grass clippings toward discharge opening 130), while mow spindle 1101 rotates clockwise, pushing newly cut grass clippings away from discharge opening 130. This configuration eliminates the row (parallel to the motion of the lawn maintenance apparatus comprising mow deck 100) of grass clippings that accumulate adjacent to discharge opening 130 in existing cutting system designs. Instead, more grass clippings exit near the center rear of the deck once the grass particles are small enough from repeated cutting by mow blades 120;.

In various embodiments, the mow spindles 110i can rotate at two or more different speeds in a mulching operating mode. For example, the speed can be greater for a mow spindle 110; that has grass clippings directed toward it by another mow spindle 110; (e.g., in FIG. 3, mow spindle 1101 has grass clippings directed toward it by mow spindle 1102, and mow spindle 1102 has grass clippings directed toward it by mow spindles 1101 and 1103, etc.) than for a mow spindle 110; that only moves grass clippings cut by itself (e.g., mow spindle 1103, etc.). This greater speed can help to move the increased quantity of grass clippings (if the mow spindle toward which the grass clippings are directed is rotating in the same direction as the mow spindle(s) directing the grass clippings towards it) or to efficiently move its own grass clippings despite increased resistance (if the mow spindle toward which the grass clippings are directed is rotating in the opposite direction from the mow spindle(s) directing the grass clippings towards it). Additionally, having two mow spindles rotating in opposite directions and each directing grass to the other can potentially lead to grass accumulation between the two if they are rotating at the same speed. To mitigate this accumulation, one of the two mow spindles can rotate at a higher speed (e.g., either because it has more mow spindles directing grass clippings toward it and/or to ensure some gradient for the grass clippings between those mow spindles, etc.).

In the example embodiment of FIG. 3, the center mow spindle 1102 can have the highest speed (e.g., 70-86% of MA, 72-84% of MA, around 84% of MA, such as around 2400-3000 (or around 2900) RPM of a MA of 3456 RPM, around 2700-3300 (or around 3200) RPM of a MA of 3820 RPM, around 3000-3700 (or around 3600) RPM of a MA of 4269 RPM, etc.), the discharge-side mow spindle 1101 can have an intermediate speed of the three mow spindles (e.g., 65-75% of MA, 67-73% of MA, around 72-73% of MA, such as around 2200-2600 (or around 2500) RPM of a MA of 3456 RPM, around 2450-2850 (or around 2750) RPM of a MA of 3820 RPM, around 2800-3200 (or around 3100) RPM of a MA of 4269 RPM, etc.), and mow spindle 1103, the farthest from discharge opening 130, can have the lowest speed (e.g., 64-69% of MA, around 66-67% of MA, such as around 2200-2400 (or around 2300) RPM of a MA of 3456 RPM, around 2450-2650 (or around 2550) RPM of a MA of 3820 RPM, around 2700-2900 (or around 2800) RPM of a MA of 4269 RPM, etc.).

In various embodiments, mulching modes of operation can provide substantial improvements in energy efficiency compared to existing mulching modes. For example, various embodiments can provide for mulching modes of operation with energy efficiency comparable to a side discharge mode of operation, which is a significant improvement over existing systems. With the example high efficiency mow deck shown in FIGS. 1-3, mulching modes of operation discussed herein can provide energy consumption 30-50% lower than side discharge modes of operation of existing cutting systems, whereas existing mulching modes of operation generally have energy consumption significantly above side discharge modes of operation of existing cutting systems.

FIG. 4 illustrates a perspective view of an example embodiment of a convertible seated/standing lawn-maintenance apparatus (in a seated position) that can employ a mow deck and/or cutting system according to any of a variety of embodiments discussed herein.

Embodiment 400 is an example lawn maintenance apparatus that can comprise or employ a mow deck as discussed herein (e.g., mow deck 100, etc.), with exceptions and/or additions as discussed below. Embodiment 400 can be powered electrically, based on an engine (e.g., gas, diesel, etc.), hybrid, etc. The prime mover (not shown) of embodiment 400 can power various powered components of embodiment 400, such as mow deck 440 and drive wheels 450. Embodiment 400 can also comprise one or more non-driven wheels 460, which can be caster wheels and/or actively steered wheels, etc.

Embodiment 400 comprises mower controls 410 (e.g., comprising lap bars, armrest mounted controls, etc.) that can be moved along control mounts via depressing triggers on handles and pushing or pulling the controls 410 to the seated (forward) or standing (rearward) position where control mount can be again locked into position. The control adjustment mechanism includes a user handle or grip along with a trigger or actuator for adjusting the controls 410 between standing mode operation in a rearward position and sitting mode operation in a forward position.

Additionally, in embodiment 400 display screen 430 and keypad 432 can be mounted from the rollover protection (ROP) bar 470, allowing access in both the seated and standing modes of operation.

In regard to the various functions performed by the above described components, machines, devices, processes and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments include a system as well as electronic hardware configured to implement the functions, or a computer-readable medium having computer-executable instructions for performing the acts or events of the various processes.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In other embodiments, combinations or sub-combinations of the above disclosed embodiments can be advantageously made. Moreover, embodiments described in a particular drawing or group of drawings should not be limited to those illustrations. Rather, any suitable combination or subset of elements from one drawing(s) can be applied to other embodiments in other drawings where suitable to one of ordinary skill in the art to accomplish objectives disclosed herein, known in the art, or reasonably conveyed to one of ordinary skill in the art by way of the context provided in this specification. Where utilized, block diagrams of the disclosed embodiments or flow charts are grouped for ease of understanding. However, it should be understood that combinations of blocks, additions of new blocks, re-arrangement of blocks, and the like are contemplated in alternative embodiments of the present disclosure.

As utilized herein, relative terms and terms of degree including the term “about”, “approximately”, “substantially”, “roughly”, “around”, “near” and others are intended to incorporate ranges and variations about a qualified term reasonably encountered by one of ordinary skill in the art in fabricating, compiling or optimizing the embodiments disclosed herein to suit design preferences, where not explicitly specified otherwise. When utilized to modify a numerical description of a disclosed element, a relative term can imply a suitable range about the given number. Any implied range is intended to be consistent with and achieve the same or similar functions as described for the disclosed structure given the numerical description, where applicable. Where such ranges are not explicitly disclosed, a range within typical manufacturing tolerances associated with suitable manufacturing equipment (e.g., injection molding equipment, extrusion equipment, metal stamping equipment, and so forth) understood by one of ordinary skill in the art for realizing an element from a disclosed illustration or description can be implied. Where ranges are explicitly described, all values within a range and all sub-ranges thereof are included within that description, where suitable. In some embodiments, depending on context and the capabilities of one of ordinary skill in the art, relative terminology can refer to a variation in a disclosed value or characteristic; e.g., a zero to five-percent variance or a zero to ten-percent variance from precise mathematically defined value or characteristic, or any suitable value or range there between can define a scope for a disclosed term of degree. As an example, a disclosed mechanical dimension can have a variance of suitable manufacturing tolerances as would be understood by one of ordinary skill in the art, or a variance of a few percent about the disclosed mechanical dimension that would achieve a stated purpose or function of the disclosed mechanical dimension. Relative terms utilized for qualitative (rather than quantitative) description can be understood to imply explicitly stated alternatives or variations, variations understood in the art to occur from manufacturing tolerances or variations in a manufacturing process, variations understood in the art to achieve the function or purpose described for a particular component or process, or a suitable combination of the foregoing. Based on the foregoing it should be understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A lawn maintenance apparatus, comprising:
a frame;
a plurality of drive wheels rotatable about a drive wheel rotation axis;
at least one of an operator seat or a standing platform secured to the frame;
operator controls for operator-initiated functions of the lawn maintenance apparatus; and
a mow deck secured to the frame, wherein the mow deck comprises a plurality of mow spindles that each comprise one or more associated mow blades, wherein each mow spindle of the plurality of mow spindles is configured to drive one or more mow blades, and wherein the mow deck is configured to operate according to one or more modes of operation, wherein the one or more modes of operation comprise a first mulch mode,
wherein in the first mulch mode of operation, the plurality of mow spindles comprises a first set of one or more mow spindles configured to rotate in a first direction and a second set of one or more mow spindles configured to rotate in a second direction that is different from the first direction.

2. The lawn maintenance apparatus of claim 1, wherein the first set of one or more mow spindles comprises a first mow spindle of the plurality of mow spindles, wherein the first mow spindle is the closest mow spindle of the plurality of mow spindles to at least one of a discharge opening of the mow deck or a mulch plug, and wherein the second set of one or more mow spindles comprises each other mow spindle of the plurality of mow spindles.

3. The lawn maintenance apparatus of claim 2, wherein in the first mulch mode, the associated mow blades of the first mow spindle are configured to rotate in the first direction to direct grass clippings away from the at least one of the discharge opening or the mulch plug.

4. The lawn maintenance apparatus of claim 1, wherein in the first mulch mode, a first mow spindle of the plurality of mow spindles is configured to rotate at a first speed, and a second mow spindle of the plurality of mow spindles is configured to rotate at a second speed that is different from the first speed.

5. The lawn maintenance apparatus of claim 4, wherein the plurality of mow spindles comprises three mow spindles, wherein the first mow spindle is the closest mow spindle of the plurality of mow spindles to at least one of a discharge opening of the mow deck or a mulch plug, and wherein the second mow spindle is a center mow spindle of the plurality of mow spindles.

6. The lawn maintenance apparatus of claim 5, wherein the second speed is greater than the first speed.

7. The lawn maintenance apparatus of claim 6, wherein in the first mulch mode, a third mow spindle of the plurality of mow spindles is configured to rotate at a third speed that is different from the first speed and the second speed.

8. The lawn maintenance apparatus of claim 7, wherein the third speed is less than the first speed.

9. The lawn maintenance apparatus of claim 8, wherein the first speed is between 65-75% of a maximum blade speed allowed by the American National Standards Institute, wherein the second speed is between 70-86% of the maximum blade speed, and wherein the third speed is between 64-69% of the maximum blade speed.

10. A lawn maintenance apparatus, comprising:
a frame;
a plurality of drive wheels rotatable about a drive wheel rotation axis;
at least one of an operator seat or a standing platform secured to the frame;
operator controls for operator-initiated functions of the lawn maintenance apparatus; and
a mow deck secured to the frame, wherein the mow deck comprises a plurality of mow spindles that each comprise one or more associated mow blades, wherein each mow spindle of the plurality of mow spindles is configured to drive one or more mow blades, and wherein the mow deck is configured to operate according to one or more modes of operation, wherein the one or more modes of operation comprise a first mulch mode,
wherein in the first mulch mode of operation, the plurality of mow spindles comprises a first set of one or more mow spindles configured to rotate at a first speed and a second set of one or more mow spindles configured to rotate at a second speed that is different from the first speed.

11. The lawn maintenance apparatus of claim 10, wherein the plurality of mow spindles comprises three mow spindles, wherein the first mow spindle is the closest mow spindle of the plurality of mow spindles to at least one of a discharge opening of the mow deck or a mulch plug, and wherein the second mow spindle is a center mow spindle of the plurality of mow spindles.

12. The lawn maintenance apparatus of claim 11, wherein the second speed is greater than the first speed.

13. The lawn maintenance apparatus of claim 12, wherein in the first mulch mode, a third mow spindle of the plurality of mow spindles is configured to rotate at a third speed that is different from the first speed and the second speed.

14. The lawn maintenance apparatus of claim 13, wherein the third speed is less than the first speed.

15. The lawn maintenance apparatus of claim 14, wherein the first speed is between 65-75% of a maximum blade speed allowed by the American National Standards Institute, wherein the second speed is between 70-86% of the maximum blade speed, and wherein the third speed is between 64-69% of the maximum blade speed.

16. The lawn maintenance apparatus of claim 11, wherein in the first mulch mode, a first mow spindle of the plurality of mow spindles is configured to rotate in a first direction, and a second mow spindle of the plurality of mow spindles is configured to rotate in a second direction that is different from the first direction.

17. The lawn maintenance apparatus of claim 16, wherein the first mow spindle is the closest mow spindle of the plurality of mow spindles to at least one of a discharge opening of the mow deck or a mulch plug, and wherein the second mow spindle is adjacent to the first mow spindle.

18. The lawn maintenance apparatus of claim 17, wherein in the first mulch mode, the associated mow blades of the first mow spindle are configured to rotate in the first direction to direct grass clippings away from the at least one of the discharge opening or the mulch plug.
